(19) United States
(12) Patent Application Publication
(10) Pub. No.: US 2012/0280915 A1
(43) Pub. Date: Nov. 8, 2012

(54) METHOD AND APPARATUS FOR FACILITATING INTERACTING WITH A MULTIMODAL USER INTERFACE

(75) Inventors: Janne Vihtori Kyllönen, Haukipudas (FI); Timo Kinnunen, Paavola (FI); Jonathon Arnowitz, San Francisco, CA (US)

(73) Assignee: Nokia Corporation

(21) Appl. No.: 13/098,664

(22) Filed: May 2, 2011

(51) Int. Cl. G06F 3/041

(52) U.S. Cl. 345/173

(57) ABSTRACT

Methods and apparatuses are provided for facilitating interaction with a multimodal user interface. A method may include displaying at least one display element on a touch display, the display element comprising a voice input capable indicator and being configured to perform an operation. The method may further include receiving a voice input. The method may additionally include causing, based at least in part on the voice input, the performance of the operation associated with the display element of the touch display user-interface.

### TECHNOLOGICAL FIELD

Example embodiments of the present invention relate generally to user interface technology and, more particularly, relate to methods and apparatuses for facilitating interaction with a multimodal user interface including a voice user interface and/or a visual user interface.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

The evolution of power and affordability of modern computing devices has included the release of computing devices that include enhanced user interface technologies, such as complex voice user interfaces. For example, voice user interfaces have allowed users to control user interfaces with a number of voice commands. In some instances, the number of possible voice commands is large, which may cause user some confusion as to which voice commands are proper and valid. Further, voice user interfaces with a number of valid voice commands may not function properly because the number of voice commands may make it difficult for the interface to distinguish which command a user stated when such a large number of potentially correct commands exist.

### BRIEF SUMMARY

Methods, apparatuses, and computer program products are herein provided for facilitating interaction with a multimodal user interface, which may include a voice user interface and a visual user interface, such as a display or graphical user interface. Further, one example embodiment may provide a method, apparatus, and computing program product for causing the performance of the operation associated with the display element of the touch display user-interface when a voice input corresponds to the at least one display element. As such, embodiments of the present invention may provide a touch display user interface and a voice user interface.

In one example embodiment, a method may include displaying at least one display element on a touch display, the display element being configured to perform an operation when touched. The method may also include receiving a voice input. In addition, the method may comprise causing the performance of an operation associated with the display element of the touch display user-interface when the voice input corresponds to the at least one display element.

In another embodiment, the method may include a display element comprising a readable command, the display element being configured to cause the performance of the operation associated with the display element of the touch display user-interface when the readable command is spoken. In another embodiment, the method may include a voice command indicator, the voice command indicator being configured to indicate the display element is configured to cause the performance of the operation associated with the display element of a touch display user-interface based at least in part upon a voice input associated with the display element. In another embodiment, the method may comprise causing the performance of the operation associated with the display element, based at least in part on the relation, further comprises causing, based at least in part on a user engaging the at least one display element by contacting the element, the performance of the operation associated with the display element of the touch display user-interface.

In another example embodiment, an apparatus may comprise at least one processor and at least one memory storing computer program code, wherein the at least one memory and stored computer program code are configured, with the at least one processor, to cause the apparatus to at least display a display at least one display element on a touch display, the display element being configured to perform an operation when touched. Further, the apparatus may comprise at least one processor and at least one memory storing computer program code, wherein the at least one memory and stored computer program code are configured, with the at least one processor, to cause the apparatus to receive a voice input. In addition, the apparatus may comprise at least one processor and at least one memory storing computer program code, wherein the at least one memory and stored computer program code are configured, with the at least one processor, to cause the apparatus to cause the performance of the operation associated with the display element of the touch display user-interface when the voice input corresponds to the at least one display element.

In another example embodiment, a computer program product is provided. The computer program product of this example embodiment may include at least one non-transitory computer-readable storage medium having computer-readable program instructions stored therein. The computer-readable program instructions may comprise program instructions configured to cause an apparatus to perform a method comprising displaying at least one display element on a touch display, the display element being configured to perform an operation when touched. The method may also include receiving a voice input. Further, the method may include causing the performance of the operation associated with the display element of the touch display user-interface when the voice input corresponds to the at least one display element.

In a further example embodiment, an apparatus is provided, which comprises means for displaying at least one display element on a touch display, the display element being configured to perform an operation when touched. The apparatus of this example embodiment additionally comprises means for receiving a voice input. In addition, the apparatus of this example embodiment also comprises causing the performance of an operation associated with the display element of the touch display user-interface when the voice input corresponds to the at least one display element.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus for facilitating interaction with a three-dimensional user interface according to an example embodiment;

FIG. 2 is a schematic block diagram of a mobile terminal according to an example embodiment;

FIG. 3 illustrates an example interaction with an example multimodal user interface according to an example embodiment;

FIG. 4 illustrates an example interaction with an example multimodal user interface according to an example embodiment; and

FIG. 5 illustrates yet another example interaction with an example multimodal user interface according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

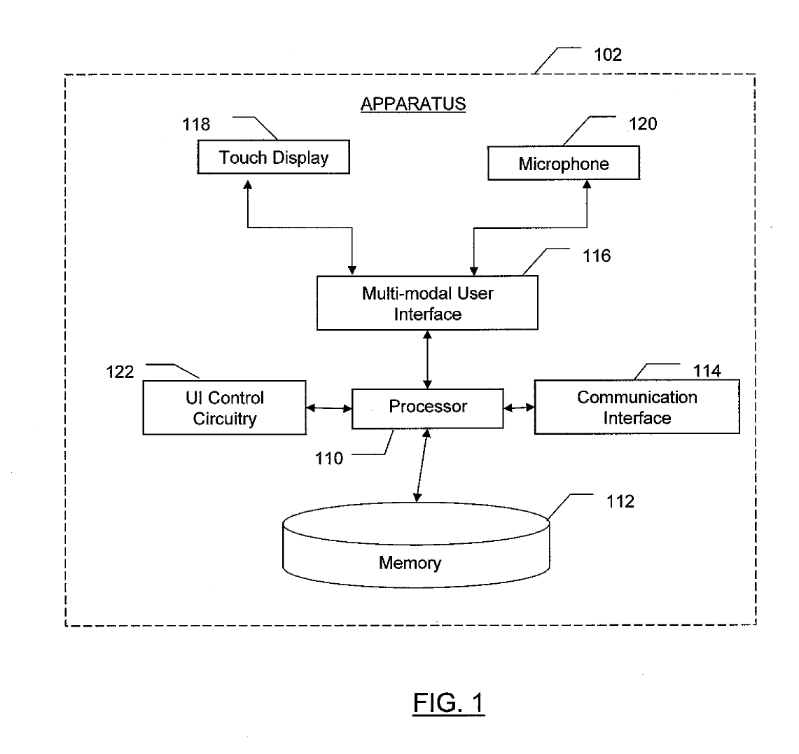

FIG. 1 illustrates a block diagram of an apparatus 102 for facilitating interaction with a multimodal user interface according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating interaction with a multimodal user interface, other configurations may also be used to implement embodiments of the present invention.

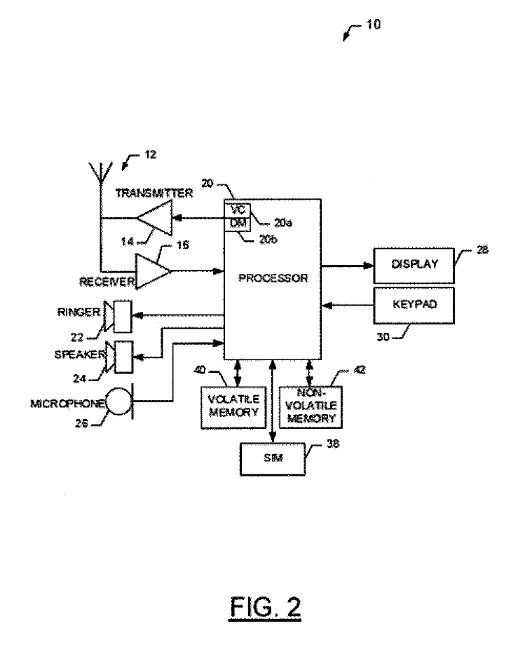

The apparatus 102 may be embodied as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a touch display capable of displaying a graphical user interface. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a multimodal user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (e.g., some example embodiments wherein the display 28 is configured as a touch display), a joystick (not shown), a microphone 26, and/or other input device.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, multi-modal user interface 116, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, multi-modal user interface 116, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42. The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, and/or UI control circuitry 122, such as via a bus.

The multi-modal user interface 116 may be in communication with the processor 110 to receive an indication of a user input and/or to provide an audible, visual, mechanical, or other output to a user. As such, the multi-modal user interface 116 may include, for example, a keyboard, a mouse, a joystick, a display, a touch screen display, a microphone, a speaker, and/or other input/output mechanisms. The user interface 116 may be in communication with the memory 112, communication interface 114, and/or UI control circuitry 122, such as via a bus.

In some example embodiments, the apparatus 102 comprises a multi-modal user interface 116 that may include a touch display 118 and a microphone 120 or other voice recording mechanism. In alternative example embodiments, such as embodiments wherein the apparatus 102 is embodied as a chip or chipset, the apparatus 102 may be operatively connected with the multi-modal user interface 116 such that the apparatus may control or otherwise interact with the touch display 118 and the microphone 120, and receive an indication of and/or otherwise determine a user input (e.g. a touch gesture input, a voice input, and/or the like) to the multi-modal user interface 116 and/or the like.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, multi-modal user interface 116, touch display 118, or microphone 120, such as via a bus.

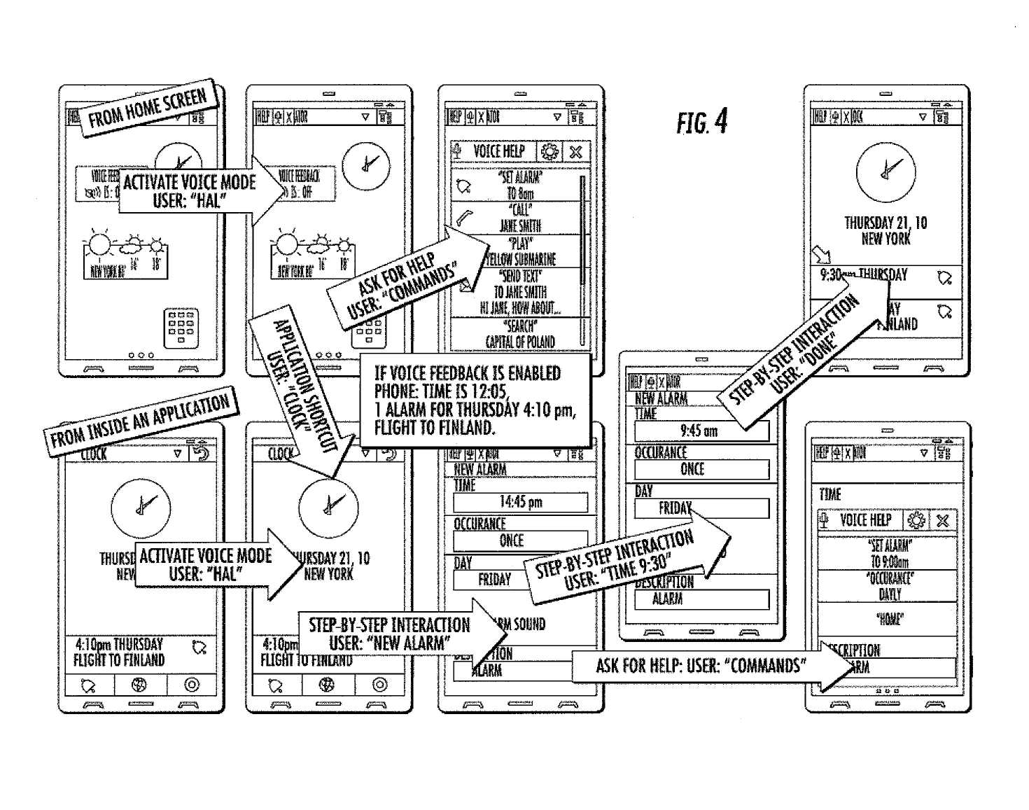

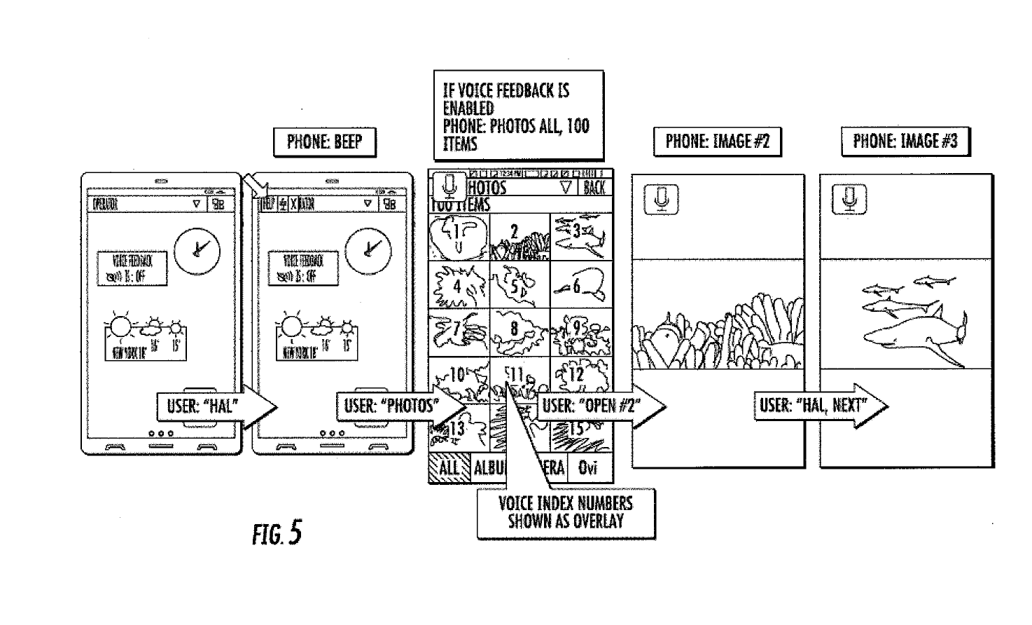

The UI control circuitry 122 may be configured to receive an indication of a voice input to the microphone 120. In this regard, for example, the microphone 120 may be configured to detect a voice input or spoken command and generate a signal indicative of the voice input. This signal may be received by the UI control circuitry 122, which may determine the voice input in response to receiving the signal, such as by determining which of a plurality of predefined verbal commands is represented by the voice input. The signal may carry information indicative of the phrase or command verbally spoken by the user. In this regard, the phrase or verbal command may or may not be associated with a visual element displayed on the touch display. Further, the UI control circuitry 122 may be configured to display a display element that includes a voice command indicator, the voice command indicator being configured to indicate the display element is configured to cause the performance of the operation associated with the display element of a touch display user-interface when a phrase or verbal command is spoken by a user. As such, the UI control circuitry 122 may be further configured to determine whether the voice input corresponds to at least one display element displayed on the touch display user-interface. If the voice input does not correspond to at least one of the display elements, the UI control circuitry 122 may be configured to prohibit the operation associated with the display element. If the voice input, however, does correspond to at least one of the display elements, the UI control circuitry 122 may be further configured to perform the operation associated with the display element. In one embodiment, the UI control circuitry may be configured to determine a voice input, which may include a phrase that identifies or corresponds to at least one of the display elements, such as by name. As shown in FIG. 4, a user may engage the UI control circuitry by activating a voice mode by stating a phrase, such as the device name. Once activated, the user may engage the UI control circuitry by launching an application by stating another phrase, such as the application name. Likewise, the user may engage the UI control circuitry by launching an application by engaging a display element of the touch display. Further still, the user may engage the UI control circuitry by activating a voice input mode by stating a phrase, such as a device name, within an already launched application. Once the application has been launched, a user may engage the UI control circuitry to operate an application by stating appropriate voice input commands corresponding to the already launched application. As shown in FIG. 4, one embodiment may include stating a phrase such as “new alarm” when operating a clock operation. Further, the UI control circuitry may be configured to receive step-by-step voice input instructions in operating an already launched application. In addition, FIG. 5 illustrates another embodiment of a user engaging a UI control circuitry by providing voice inputs.

FIG. 4 illustrates an example interaction with an example multimodal user interface according to an example embodiment. Specifically, FIG. 4 illustrates a user interaction with an example multimodal user interface to create a new alarm on an exemplary mobile device. Further, FIG. 4 illustrates that a voice input user interface may be activated from either a home screen or from within an application that is currently running on the apparatus, such as a mobile device. A user may activate the voice input user interface on an exemplary apparatus by speaking the name of the apparatus into a microphone or other voice input device. In FIG. 4, a user may activate the voice input user interface by stating “Hal” to the apparatus. If the user activates the voice input user interface from a home screen, the user may activate an application by stating the application name, such as “Clock” to the apparatus. Further, a user may access a list of valid and applicable commands at any point during operation of the device by stating “Commands.” When a help screen is activated, the touch display may be configured to display touch elements corresponding to operations configured to be activated by a voice input. In another embodiment, the touch elements may further include an indicator or flag, which is also displayed on the touch display, to indicate the touch element may be activated with an appropriate voice input. As shown in FIGS. 4 and 5, the voice input may correspond to a readable command, the readable command corresponding to a displayed touch element. When a help screen is activated, the user may engage the UI control circuitry by stating the readable command to cause the performance of an operation.

Once a user has activated an application by stating the application name from the home screen or has activated the voice input user interface from within the desired application, the user may interact with an exemplary device by stating the appropriate commands, such as “New alarm” when interacting with a clock application. The device may also indicate existing alarms when the “New alarm” command is spoken and may further indicate the current time. The user may also interact with an exemplary device with a voice input user interface to establish desired parameters for a desired operation, such as establishing the time for a new alarm, by stating an appropriate voice command, such as “Time 9:30.” When a user has finished selecting the desired parameters, the user may complete the interaction with an exemplary device by stating the command “Done.”

FIG. 5 also illustrates an example interaction with an example multimodal user interface according to an example embodiment. Specifically, FIG. 5 illustrates a user interaction with a multimodal user interface to view images within a photo library of an exemplary device. The user may activate the voice input user interface by stating the device name, “Hal.” Once the voice input user interface has been activated, the user may open a photo library application by either engaging the touch display element associated with the photo library application or by providing a voice command associated with the touch display element, such as “Photos.” If the voice input user interface has been enabled, the device may indicate the number of photos available for viewing by stating “Photos All, 100 items.” Further, the touch display elements associated with each individual photo may include a number superimposed on the photo. As such, a user may select a particular photo for viewing with the voice input user interface by indicating the specific photo the user desires to be viewed as a full image. For example, a user may state “Image #2” and the voice input user interface may be configured to display the second photo as a full image. The device may further be configured to confirm the second image is being displayed by providing an audio output of “Image #2.” Further, a user may proceed to view the next image by stating “Hal, next.” In response, the device may be configured to announce the next image is being displayed by providing an audio output of “Image #3.”

In another embodiment, the UI control circuitry may be configured to receive a touch input to a touch display. According to another embodiment, the UI control circuitry may be configured to perform an operation associated with a touch input when the user engages the touch display by contacting a display element. Further, if the user has not enabled a voice input mode, the UI control circuitry may be configured to perform an operation associated with a touch input, but not a corresponding voice input, unless the user enables a voice input mode. In another embodiment, the UI control circuitry may be configured to be engaged by a user with a voice input and a touch input, or the like, simultaneously.

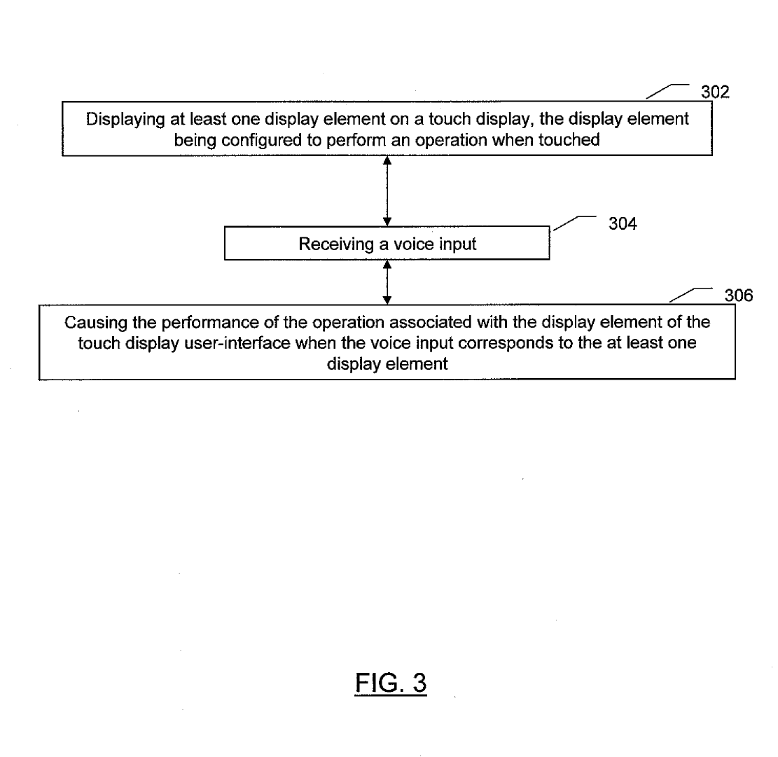

FIG. 3 illustrates a flowchart according to an example method for facilitating interaction with multi-modal user interface according to an example embodiment. The operations illustrated in and described with respect to FIG. 3 may, for example, be performed by, with the assistance of, and/or under the control of one or more of the processor 110, memory 112, communication interface 114, multi-modal user interface 116, touch display 118, microphone 120, or UI control circuitry 122. Operation 302 may comprise causing display of at least one display element on a touch display 118, the display element being configured to perform an operation when touched or otherwise actuated. The processor 110, memory 112, multi-modal user interface 116, touch display 118, microphone 120, and/or UI control circuitry 122 may, for example, provide means for performing operation 302. Operation 304 may comprise receiving a voice input. The processor 110, memory 112, multi-modal user interface 116, touch display 118, microphone 120, and/or UI control circuitry 122 may, for example, provide means for performing operation 304. Operation 306 may comprise causing the performance of the operation associated with the display element of the touch display user-interface when the voice input corresponds to the at least one display element. The processor 110, memory 112, multi-modal user interface 116, touch display 118, microphone 120 and/or UI control circuitry 122 may, for example, provide means for performing operation 306.

Further, FIG. 3 illustrates a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
causing display of at least one display element on a display, the display element being configured to perform an operation when touched;
receiving a voice input; and
causing the performance of the operation associated with the display element of the display when the voice input corresponds to the at least one display element.

2. A method of claim 1, wherein the display element further comprises a readable command, the readable command being configured to cause the performance of the operation associated with the display element of a touch display user-interface.

3. A method of claim 1, wherein the display element further comprises a voice command indicator, the voice command indicator being configured to indicate the display element is configured to cause the performance of the operation associated with the display element of a touch display user-interface based at least in part upon a voice input associated with the display element.

4. A method of claim 1, wherein causing the performance of the operation associated with the display element further comprises causing, based at least in part on a user engaging the at least one display element by contacting the element, the performance of the operation associated with the display element of a touch display user-interface.

5. A method of claim 1, wherein the display further comprises a touch display, the touch display configured to display a touch display element.

6. A method of claim 1, further comprising causing the performance of an operation associated with the display element by simultaneously engaging the touch display and providing a user interface control circuitry with a voice input.

7. An apparatus comprising at least one processor and at least one memory storing computer program code, wherein the at least one memory and stored computer program code are configured, with the at least one processor, to cause the apparatus to at least:
cause the display at least one display element on a display, the display element being configured to perform an operation when touched;
receive a voice input; and
cause the performance of the operation associated with the display element of the display when the voice input corresponds to the at least one display element.

8. The apparatus of claim 7 further comprising a mobile phone, the phone comprising a touch display user-interface.

9. The apparatus of claim 7 further comprising a touch display, the touch display, configured to display a touch display element.

10. The apparatus of claim 7, wherein the display element further comprises a readable command, the readable command being substantially the same as the voice input configured to cause the performance of the operation associated with the display element of the touch display user-interface.

11. The apparatus of claim 7, wherein the display element further comprises a voice command indicator, the voice command indicator being configured to indicate the display element is configured to cause the performance of the operation associated with the display element of a touch display user-interface based at least in part upon a voice input associated with the display element.

12. The apparatus of claim 7, wherein the at least one memory and stored computer program code are configured, with the at least one processor, to cause the apparatus to cause, based at least in part on a user engaging the at least one display element by contacting the element, the performance of the operation associated with the display element of the touch display user-interface.

13. The apparatus of claim 7, wherein the at least one memory and stored computer program code are configured, with the at least one processor, to cause the apparatus to cause the performance of an operation associated with the display element of the touch display user-interface by engaging a touch display element simultaneously with providing a user interface control circuitry with a voice input.

14. A computer program product comprising at least one non-transitory computer-readable storage medium having computer-readable program instructions stored therein, the computer-readable program instructions comprising program instructions configured to cause an apparatus to perform a method comprising:
causing display of at least one display element on a display, the display element being configured to perform an operation when touched;
receiving a voice input; and
causing the performance of the operation associated with the display element of the display when the voice input corresponds to the at least one display element.

15. The computer program product of claim 14, wherein the display element further comprises a readable command, the readable command being substantially the same as the voice input configured to cause the performance of the operation associated with the display element of the touch display user-interface.

16. The computer program product of claim 14, wherein the display element further comprises a voice command indicator, the voice command indicator being configured to indicate the display element is configured to cause the performance of the operation associated with the display element of a touch display user-interface based at least in part with a voice input associated with the display element.

17. The computer program product of claim 14, wherein causing the performance of the operation associated with the display element further comprises causing, based at least in part on a user engaging the at least one display element by contacting the element, the performance of the operation associated with the display element of the touch display user-interface.

18. The computer program product of claim 14 further comprising a touch display, the touch display configured to display a touch display element.

19. The computer program product of claim 14 further causing the performance of an operation associated with the display element by simultaneously engaging the touch display and providing a user interface control circuitry with a voice input.
